(19) United States
(12) Patent Application Publication
(10) Pub. No.: US 2005/0246941 A1
(43) Pub. Date: Nov. 10, 2005

(54) PIVOTING JIG HEAD FOR A FISHING LURE

(76) Inventor: Allan David Mitchell, Cronulla (AU)

Correspondence Address: STEPHEN CHRISTOPHER SWIFT;SWIFT LAW OFFICE, SUITE 200, 1940 DUKE STREET, ALEXANDRIA, VA, 22314-3451, US

(21) Appl. No.: 11/161,019

(22) Filed: Jul. 20, 2005

Related U.S. Application Data
(63) Continuation-in-part of application No. 10/856,944, filed on Jun. 1, 2004.
Application No. 10/856,944 is a continuation-in-part of application No. 10/375,035, filed on Feb. 28, 2003, now abandoned.
(60) Provisional application No. 60/361,199, filed on Feb. 28, 2002.

(51) Int. Cl. A01K 85/00

(52) U.S. Cl. 43/42.36; 43/42.39

(57) ABSTRACT

A jig head, to which a fishing lure may be attached, that can pivot on a fish hook or clip to attract fish as it is pulled through the water on a fishing line. There is a channel through the jig head, through which the fish hook or clip is inserted, so that the jig head (and the attached lure) can pivot on the hook or clip. As the fish hook is not permanently attached to the jig head, it will be easy to replace a worn or damaged hook, while reusing the jig head with a new hook. There may be a second channel through the jig head, through which water can flow, to further attract fish by the sound of the water flowing through the jig head and lure, and optionally to help disperse an attractive scent from the lure into the water.

### CROSS REFERENCE TO RELATED APPLICATIONS

This application is a Continuation-ln-Part of Regular Utility patent application No. 10/856,944, filed on Jun. 4, 2004, which was a Continuation-In-Part of Regular Utility patent application No. 10/375,035, filed on Feb. 28, 2003 (now abandoned), which was based on Provisional Patent Application Ser. No. 60/361,199, filed on Feb. 28, 2002.

### BACKGROUND OF THE INVENTION

1. Field of the Invention

The present invention relates to apparatus used to attract and catch fish.

2. Description of the Prior Art

In the art of fishing there are devices that are known as jigs, which are usually weighted with lead or steel. Commonly, a hook portion of the jig supports a soft plastic tube bait, live bait, a skirt or other attractant to fish. A problem with the prior art is that the jig head is fixed in an immovable fashion to the hook. This severely limits the swimming or undulating motion available to the attractor portion of the combination.

U.S. Pat. No. 456,931, issued on Aug. 4, 1891, to Albert Angel, discloses a revolving wing attachment for fish hooks. The instant invention is distinguishable in that it does not require revolving wings.

U.S. Pat. No. 570,632, issued on Nov. 3, 1896, to James T. Hastings, discloses a fish hook to which is attached a piece of sheet metal that spins about the hook. The instant invention is distinguishable in that it does not require a piece of sheet metal spinning about a hook.

U.S. Pat. No. 1,116,025, issued on Nov. 3, 1914, to Charles E. Cripe, discloses a cone-shaped artificial lure with propeller shaped blades that spins about a fish hook. The instant invention is distinguishable in that it involves pivoting rather than spinning.

U.S. Pat. No. 1,313,567, issued on Aug. 19, 1919, to Charles B. Ulrich, discloses a trolling attachment for fishing lines, with a spinner that spins about an axis in the direction in which it is pulled. The instant invention is distinguishable in that it involves pivoting about an axis that is different from the direction in which the lure is pulled.

U.S. Pat. No. 1,573,288, issued on Feb. 16, 1926, to Albert W. Wilson, discloses a trolling gear with spinner having a channel or “opening” 14 that is open along one side of its axis, rather than merely at its ends, as in the instant invention.

U.S. Pat. No. 1,830,080, issued on Nov. 3, 1931, to Harold G. Allen, discloses a fish lure that when drawn through the water flaps or oscillates its wings to simulate a struggling insect or small bird. The instant invention is distinguishable in that it does not require wings.

U.S. Pat. No. 1,871,971, issued on Aug. 16, 1932, to Frederick E. Eppich, discloses fish lure having a plate designed to spin about an axis in the direction it is pulled, rather than pivot back and forth like the jig head of the instant invention.

U.S. Pat. No. 2,027,069, issued on Jan. 7, 1936, to Wendell L. Sorenson, discloses an artificial bait that can simulate the body movement of fish in motion. The instant invention is distinguishable, in that it has a jig head that has a channel through which a hook can pass, so that the jig head can pivot on the hook.

U.S. Pat. No. 2,091,457, issued on Aug. 31, 1937, to Rudolph Sauer, discloses a fish lure, having a pin on which a hook can pivot, and which disperses an oil or other liquid into the water to attract fish. The instant invention is distinguishable, in that it has a jig head with a channel through which a hook can pass.

U.S. Pat. No. 2,112,901, issued on Apr. 5, 1938, to Charles N. Anderson, discloses a fish lure that darts back and forth on the fishing line, rather than pivoting about a hook as in the instant invention.

U.S. Pat. No. 2,167,334, issued on Jul. 25, 1939, to James H. Hayes, discloses an artificial bait constructed to simulate the appearance of an eel, with channels for the passage of water to inflate an eel skin (or a simulation thereof) as the lure is pulled through the water. The instant invention is distinguishable, in that it has a channel through a jig head for a hook.

U.S. Pat. No. 2,294,971, issued on Sep. 8, 1942, to Charles E. Fehringer, discloses a fish lure, having wings that spin around an axis in the direction that the lure is pulled, rather than pivoting in a different direction, as in the instant invention.

U.S. Pat. No. 2,593,199, issued on Apr. 15, 1952, to Arnold J. Salg, discloses an artificial bait having passageways for water, but not a channel on which it can pivot on a hook, as in the instant invention.

U.S. Pat. No. 2,792,663, issued on May 21, 1957, to Robert C. Sinclair, discloses a fishhook attached to a float that is attached to a line attached to a sinker that rests on the bottom of a body of water. Movement of the water causes the line, float and hook to undulate. The instant invention is distinguishable, in that it pivots as it is pulled through the water.

U.S. Pat. No. 2,836,001, issued on May 26, 1958, to Melvin L. Silen, discloses a fish lure having an axial bore through which a line is extended, and one or more channels filled with an absorbent material. The instant invention is distinguishable, in that it has channel on which the jig head can pivot on a hook.

U.S. Pat. No. 3,010,243, issued on Nov. 28, 1961, to John T. Dickinson, discloses a convertible fishing lure, with a cylindrical bore that may extend diagonally through the lure, but it does not disclose the retention of the straight portion of a hook in the bore or channel, as in the instant invention.

U.S. Pat. No. 4,098,017, issued on Jul. 4, 1978, to Joe Patrick Hall, discloses fishing lure through which water flows and makes noise, but does not disclose a channel through which a hook can pass, as in the instant invention.

U.S. Pat. No. 4,803,798, issued on Feb. 14, 1989, to Dan L. Hannah, discloses a fishing sinker designed to align a fishhook so that the main barb of the hook is directed toward the upper or lower portion of a fish's mouth. It does not disclose a channel with two open ends through which a hook can pass, as in the instant invention.

U.S. Pat. No. 4,843,754, issued on Jul. 4, 1989, to Harold F. Spelts, discloses a fishhook and lure, designed to prevent the lure from rotating, rather than allowing it to pivot, as in the instant invention.

U.S. Pat. No. 5,142,811, issued on Sep. 1, 1992, to Carl W. Freeman, discloses a fishing lure and lure enhancement kit, in which a shank portion of a hook is disposed within a bore, but does not disclose a channel through which the hook can pass in such a manner that the lure can pivot on the hook, as in the instant invention.

U.S. Pat. No. 6,035,574, issued on Mar. 14, 2000, to Brett Ware, discloses a fishing lure with a shaft passing through its body designed to cause water passing through the shaft to generate vibrations of a pre-determined frequency known to attract fish. A hook is securely fastened to the body, but does not pivot within the body, nor does the lure pivot about the hook, as in the instant invention.

U.S. Pat. No. 6,505,432, issued on Jan. 14, 2003, to Stephen M. Brinkman, discloses a fish catching system, including a decapod-shaped lure that pivots when it is manipulated by the user, rather than pivoting spontaneously when it is pulled through the water, as in the instant invention.

U.S. Pat. No. 6,519,895, issued on Feb. 18, 2003, to Thomas Joseph Bennett, discloses a fish hook for use with bait, with an elongated shank have first and second ends for attachment to the bait, rather than a straight portion that passes through a channel in a jig head, as in the instant invention.

U.S. Pat. No. 6,546,663, issued on Apr. 15, 2003, to Paul Signitzer, Andrew Fogarty and Michael Fogarty, discloses a fishing lure, which simulates the tail flicking of a crustacean, but does not pivot about a hook, as in the instant invention.

U.S. Pat. No. Des. 331,788, issued on Dec. 15, 1992, to Leslie R. Jensen, discloses a design for a combined lure holder and weed guard, in which the lure is held by a clamp, rather than pivoting on a hook, as in the instant invention.

U.S. patent application Publication No. 2002/0078619, published on Jun. 27, 2002, inventor Michael E. Hurtle, Jr., discloses a tube lure, which does not pivot on a hook, as in the instant invention.

Japanese Patent Application No. 5-227862, published on Sep. 7, 1993, to Horimoto Toshikazu, discloses a jig head with a fish-shaped sinker of lead attached to the shank of a hook, but the shank of the hook does not pass through a channel in the jig head, as in the instant invention.

None of the above inventions and patents, taken either singly or in combination, is seen to describe the instant invention as claimed.

### SUMMARY OF THE INVENTION

The present invention is a jig head, to which a fishing lure may be attached, that can pivot on a fish hook or clip to attract fish as it is pulled through the water on a fishing line. There is a channel through the jig head, through which the fish hook or clip is inserted, so that the jig head (and the attached lure) can pivot on the hook or clip. As the fish hook is not permanently attached to the jig head, it will be easy to replace a worn or damaged hook, while reusing the jig head with a new hook. There may be a second channel through the jig head, through which water can flow, to further attract fish by the sound of the water flowing through the jig head and lure, and optionally to help disperse an attractive scent from the lure into the water.

Accordingly, it is a principal object of the invention to provide an improved jig head for a fishing lure that will attract fish by its pivoting motions.

It is another object of the invention to provide an improved jig head for a fishing lure that may be separated from the hook on which it is retained.

It is a further object of the invention to provide an improved jig head for a fishing lure that will attract fish by sound.

Still another object of the invention is to provide an improved jig head for a fishing lure will attract fish by releasing scent into the water.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top plan view of the first preferred embodiment of the invention.

FIG. 2 is a right side elevational view of the first preferred embodiment of the invention.

FIG. 3 is a front elevational view of the of the first preferred embodiment of the invention.

FIG. 4 is a rear elevational view of the first preferred embodiment of the invention.

FIG. 5 is a top plan view of the second preferred embodiment of the invention.

FIG. 6 is a right side elevational view of the second preferred embodiment of the invention.

FIG. 7 is a front elevational view of the second preferred embodiment of the invention.

FIG. 8 is a rear elevational view of the second preferred embodiment of the invention.

FIG. 9 is a top plan view of the third preferred embodiment of the invention.

FIG. 10 is a right side elevational view of the third preferred embodiment of the invention.

FIG. 11 is a front elevational view of the of the third preferred embodiment of the invention.

FIG. 12 is a rear elevational view of the third preferred embodiment of the invention.

FIG. 13 is a top plan view of the fourth preferred embodiment of the invention.

FIG. 14 is a right side elevational view of the fourth preferred embodiment of the invention.

FIG. 15 is a front elevational view of the fourth preferred embodiment of the invention.

FIG. 16 is a schematic view illustrating the first two steps in a first method of using the invention.

FIG. 17 is a schematic view illustrating the third step in the first method of using the invention.

FIG. 18 is a schematic view illustrating the fourth step in the first method of using the invention.

FIG. 19 is a schematic view illustrating the first two steps in a second method of using the invention.

FIG. 20 is a schematic view illustrating the third step in the second method of using the invention.

FIG. 21 is a schematic view illustrating the fourth step in the second method of using the invention.

FIG. 22 is a schematic view illustrating the first two steps in a third method of using the invention.

FIG. 23 is a schematic view illustrating the third step in the third method of using the invention.

FIG. 24 is a schematic view illustrating the fourth step in the third method of using the invention.

Similar reference characters denote corresponding features consistently throughout the attached drawings.

### DETAILED DESCRIPTION OF THE PREFERRED EMBODIMENTS

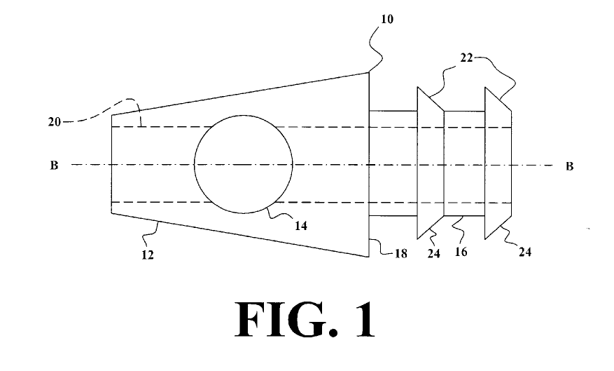

FIG. 1 is a top plan view of the first preferred embodiment of the invention 10, showing the frustoconical main body 12, through which passes a first cylindrical channel 14. An attachment member 16 extends from the base 18 of the frustoconical main body. The attachment member preferably has a generally cylindrical shape. (Alternatively, the attachment member may have a generally conical or frustoconical shape, or any other suitable shape.) Preferably, the main body and the attachment member share a common axis B-B. There is a second cylindrical channel 20, which passes through the main body and the attachment member, sharing axis B-B, and intersects the first channel. One or more gripping members 22 extend from the outer surface of the attachment member, to enable a lure to be retained on the invention. Preferably, the gripping members are frustoconical flanges, having sides 24 that slope in a direction opposite to the direction that the side 26 of the main body slopes. Alternatively, the gripping members may be one or more screw threads, or any other suitable shape.

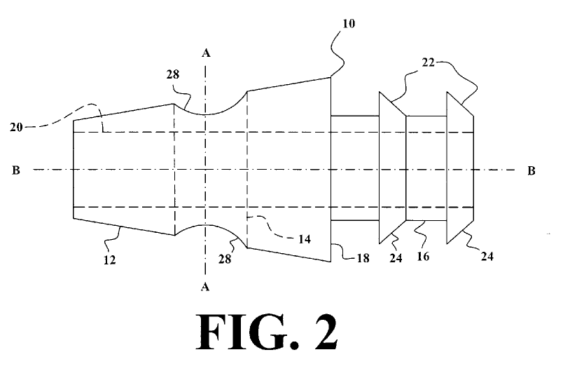

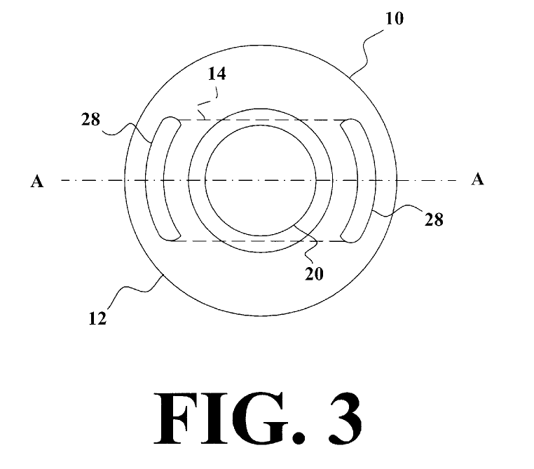

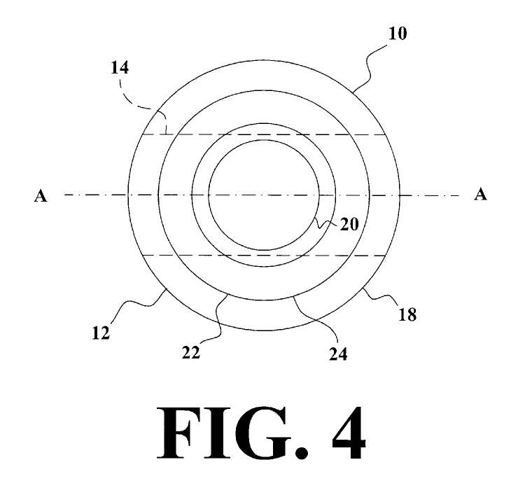

FIG. 2 is a right side elevational view of the first preferred embodiment of the invention, showing the open ends 28 and axis A-A of the first cylindrical channel. Preferably, the first channel is at right angles to the second channel. The purpose of the first channel is so that the jig head (and an attached lure) can pivot on a fish hook (or pivot on a clip to which a fish hook and fishing line are attached) thus attracting fish. The purpose of the second channel is so that water can flow through the jig head (and an attached lure) as it pulled through the water, which may enhance attractive motions of the lure, create sonic effects that further attract fish, and perhaps help disperse an attractive scent from the lure. FIG. 3 is a front elevational view of the of the first preferred embodiment of the invention. FIG. 4 is a rear elevational view of the first preferred embodiment of the invention. Because of the second channel, the first preferred embodiment may be referred to as the “hollow point” version of the invention.

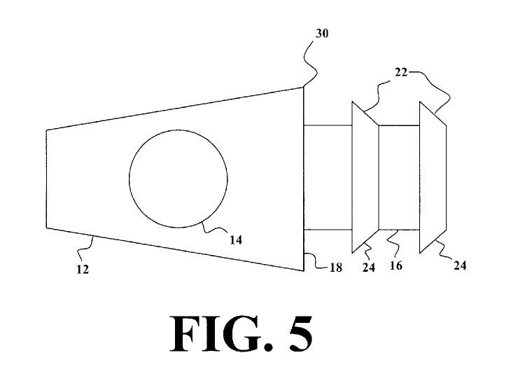

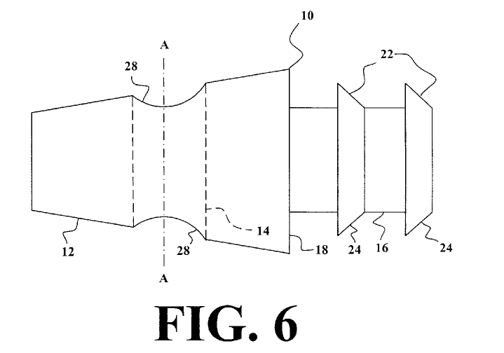

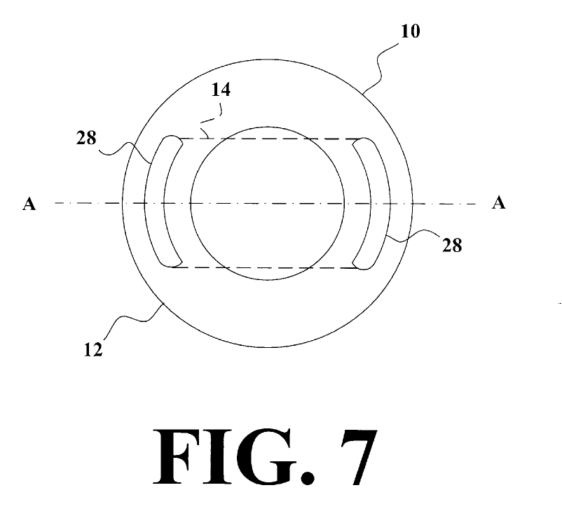

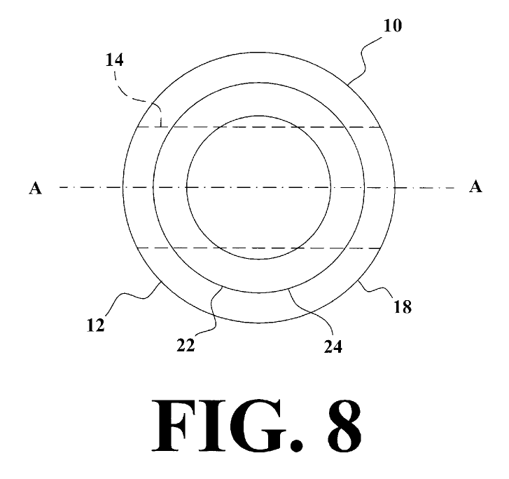

FIG. 5 is a top plan view of the second preferred embodiment of the invention 30, which is the same as the first preferred embodiment, except that it does not have the second channel. This may be preferable where it is desirable to have a heavy jig head and/or important to keep the jig free from weeds. FIG. 6 is a right side elevational view of the second preferred embodiment of the invention. FIG. 7 is a front elevational view of the of the second preferred embodiment of the invention. FIG. 8 is a rear elevational view of the second preferred embodiment of the invention. Because of the absence of the second channel, the second preferred embodiment may be referred to as the “solid” version of the invention.

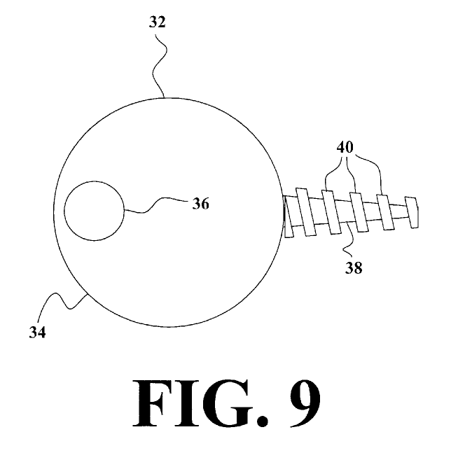

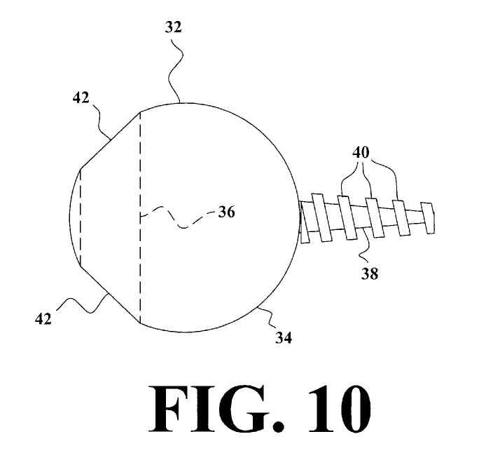

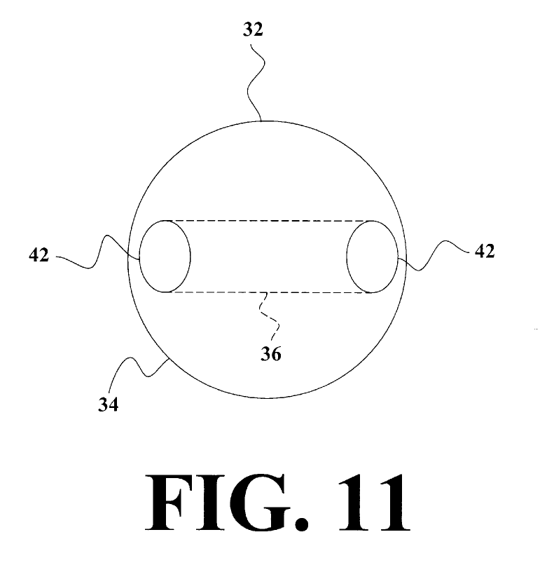

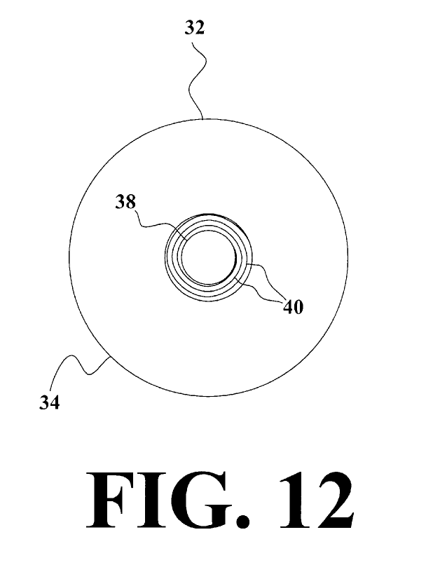

FIG. 9 is a top plan view of the third preferred embodiment of the invention 32, having a main body 34 that is generally spherical, a single channel 36 passing through the main body, an attachment member 38 extending from the main body, and one or more gripping members 40 extending from the outer surface of the attachment member, by which a lure may be retained on the invention. The third preferred embodiment may be referred to as the “snub nose” version of the invention. Like the second preferred embodiment, this may be preferable where it is desirable to have a heavy jig head and/or important to keep the jig free from weeds. Its shape may be desirable in fly fishing. The attachment member preferably has a generally frustoconical shape. (Alternatively, it may have a generally cylindrical or conical shape, or any other suitable shape.) FIG. 10 is a right side elevational view of the third preferred embodiment of the invention, showing the open ends 42 of the channel 36. The channel is preferably cylindrical and at right angles to the attachment member. The gripping members are preferably one or more screw threads. (Alternatively, the gripping members may be frustoconical flanges, having sides that slope downward in a direction away from the main body, or they may be any other suitable shape.) FIG. 11 is a front elevational view of the of the third preferred embodiment of the invention. FIG. 12 is a rear elevational view of the third preferred embodiment of the invention.

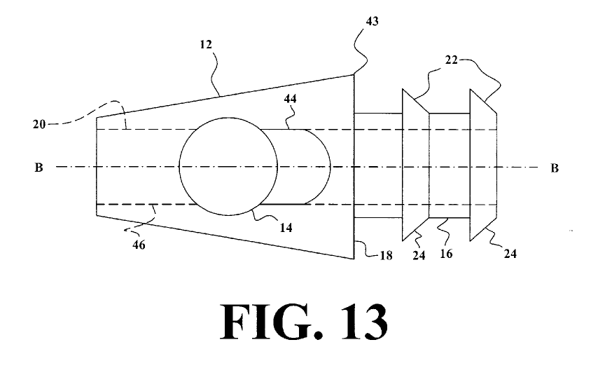

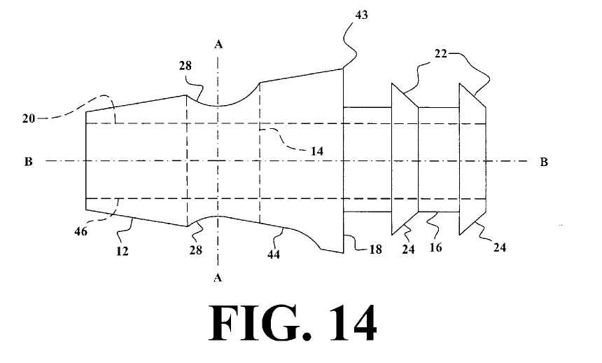

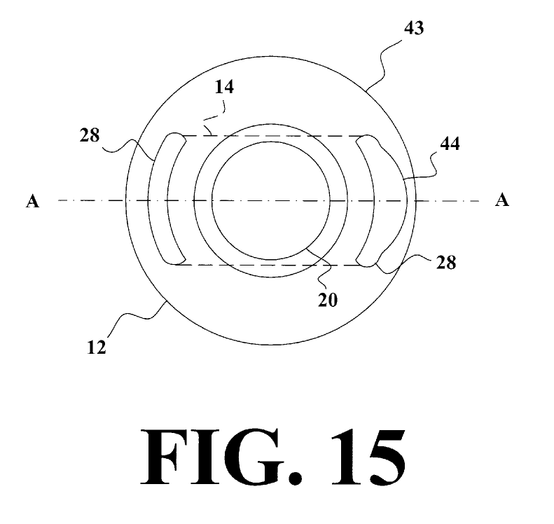

FIG. 13 is a top plan view of the fourth preferred embodiment of the invention 43, which is the same as the first preferred embodiment, except that there is a recess 44 adjacent to one of the open ends 28 of the first cylindrical channel 14, which is suitably dimensioned and configured to allow a fish hook to be inserted into the first channel and then through a front portion 46 of the second channel. It is designed for use with the third method of using the invention, as explained below. FIG. 14 is a right side elevational view of the fourth preferred embodiment of the invention. FIG. 15 is a front elevational view of the of the fourth preferred embodiment of the invention. (The rear elevational view is the same as in the first preferred embodiment.)

All of the preferred embodiments are made of brass that is an alloy of copper, zinc and perhaps a small amount of lead. Brass has fish attracting sonic properties that make it more desirable in a jig head than other metals. Preferably, the lead is no more than five percent by weight of the brass, as lead is known to have toxic properties. Alternatively, the invention may be made of any suitable material.

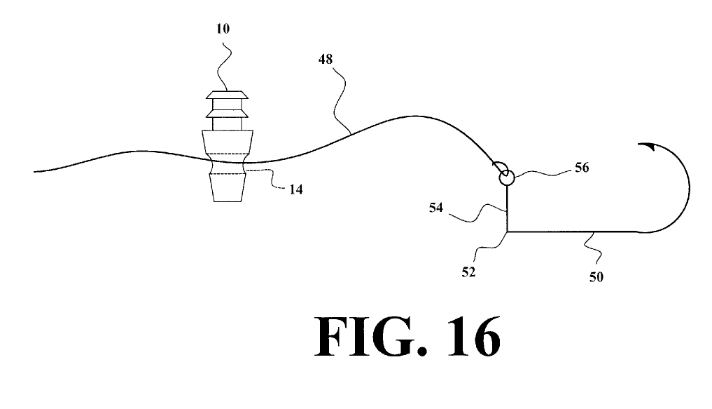

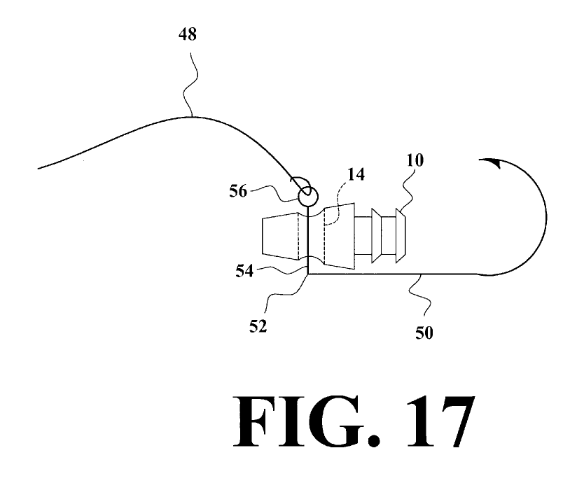

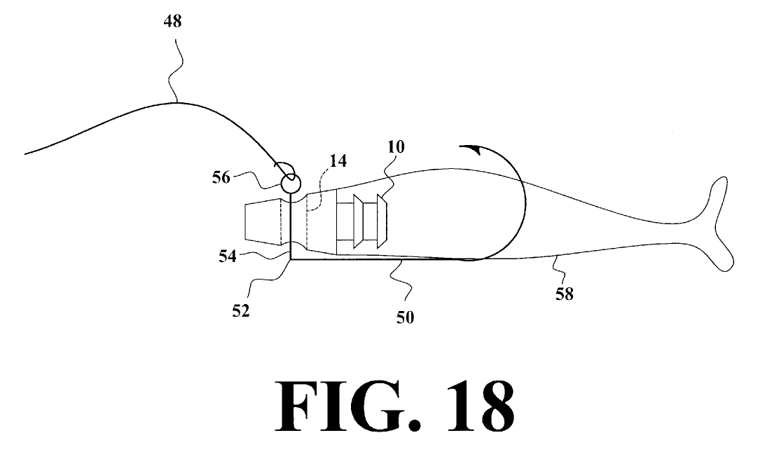

FIG. 16 is a schematic view illustrating the first two steps in a first method of using the invention. It is illustrated using the first preferred embodiment 10, but it may be used with any embodiment of the invention. First, the jig head 10 is threaded onto a fishing line 48. The line is threaded through the first channel 14. The hook 50 with a single right angled bend 52 and a straight shank 54 is tied to a loose end of the line at the eye 56 of the hook. FIG. 17 is a schematic view illustrating the third step in the first method of using the invention, in which the eye of the hook is inserted through the first channel, so that the straight shank lies in the channel. FIG. 18 is a schematic view illustrating the fourth step in the first method of using the invention, in which a lure 58 or bait is connected to the jig head. The jig head and the attached lure will now pivot on the shank of the hook as the jig is pulled through the water.

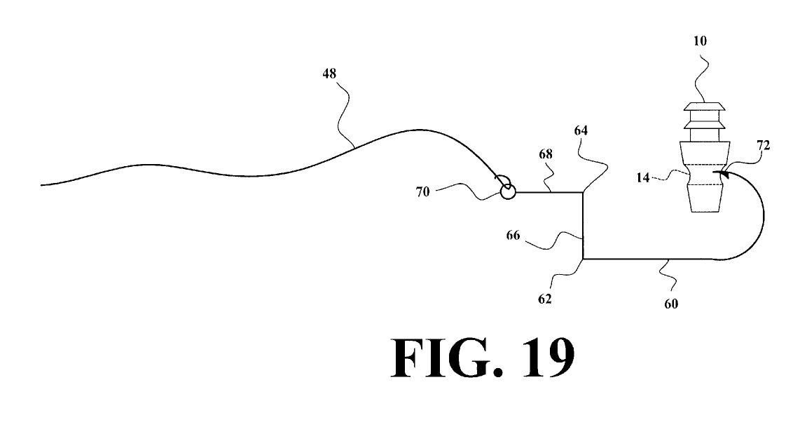

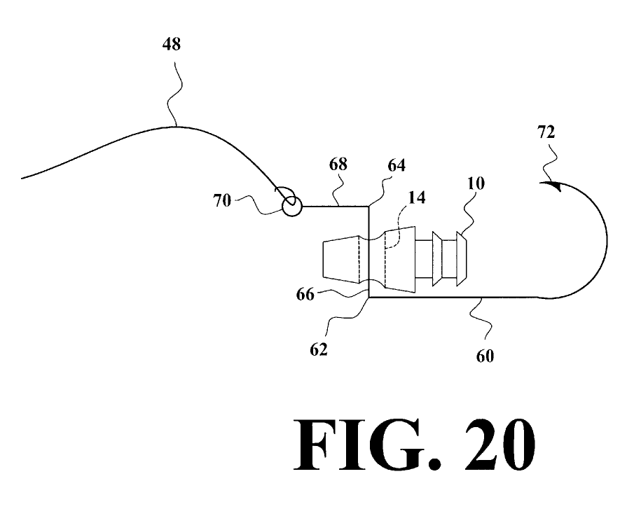

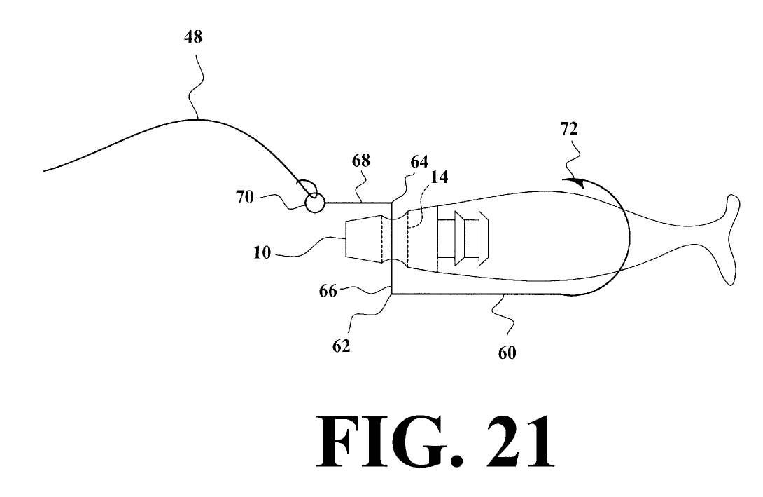

FIG. 19 is a schematic view illustrating the first two steps in a second method of using the invention. Again, it is illustrated using the first preferred embodiment 10, but it may be used with any embodiment of the invention. First, a hook 60, having a two right angled bends 62 and 64, a straight middle portion 66, a straight end portion 68, an eye 70, and a barb 72, is tied at its eye to a loose end of the fishing line 48. Second, the barb of the hook is inserted into the first channel 14 of the jig head 10. FIG. 20 is a schematic view illustrating the third step in the second method of using the invention, in which the jig head is slid up the hook and manipulated so that the straight middle portion of the hook lies in the first channel of the jig head. FIG. 21 is a schematic view illustrating the fourth step in the second method of using the invention, in which the lure 58 or bait is connected to the jig head. The jig head and the attached lure will now pivot on the straight middle portion of the hook as the jig is pulled through the water.

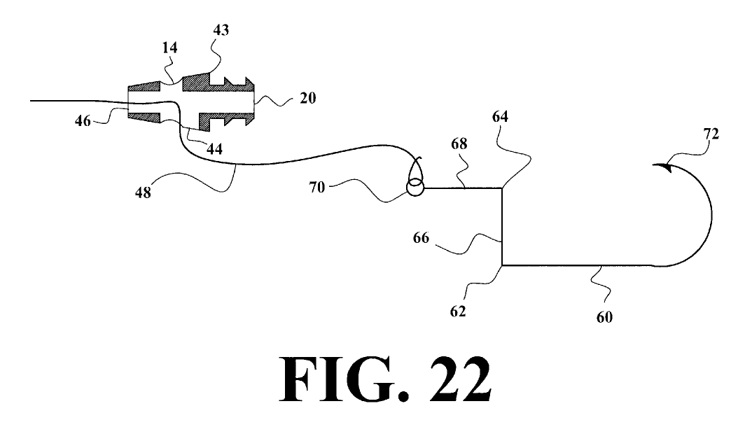

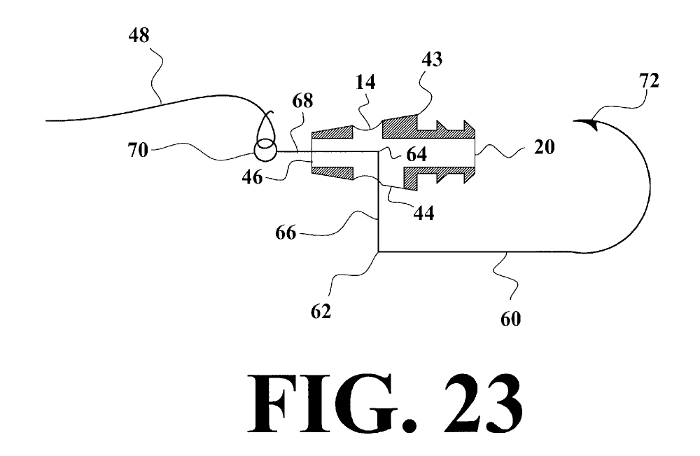

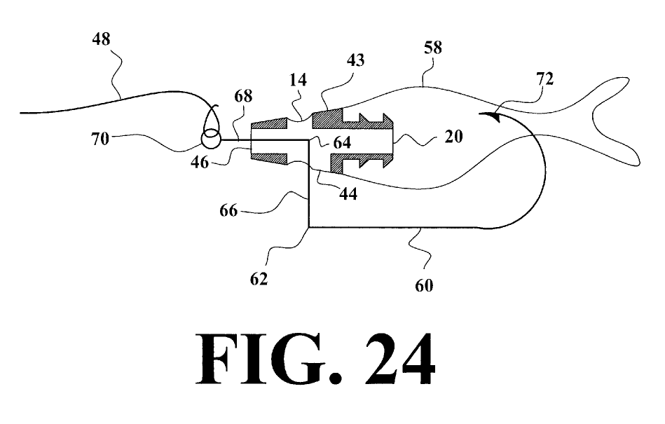

FIG. 22 is a schematic view illustrating the first two steps in a third method of using the invention, for which the fourth preferred embodiment of the invention 43 is designed. First, the loose end of the fishing line 48 is threaded through the front portion 46 of the second channel 20 and then through the side of the first channel 14 having the recess 44. (The fourth preferred embodiment is here shown in cross section to reveal its internal structure.) Second, the loose end of the fishing line is tied to the eye 70 of the same hook 60 as is used in the second method. FIG. 23 is a schematic view illustrating the third step in the third method of using the invention, in which the jig head is slid on the line, and the eye 70 of the hook is passed the side of the first channel 14 having the recess 44, and then through the front portion 46 of the second channel 20, so that the middle straight portion 66 of the hook lies in the first channel, and the straight end portion 68 lies in the second channel. FIG. 24 is a schematic view illustrating the fourth step in the third method of using the invention, in which the lure 58 or bait is connected to the jig head. Although the third method does not allow the jig head to pivot as in the first and second methods, it does allow the jig head to vibrate on the hook, creating a desirable sonic attraction to fish.

It is to be understood that the present invention is not limited to the embodiments described above, but encompasses any and all embodiments within the scope of the following claims.

1. A fishing jig, comprising:
a frustoconical main body;
a first cylindrical channel having two open ends, that passes through the main body;
an attachment member, having a general shape selected from the group comprising cylindrical, conical and frustoconical, said attachment member being coaxial with, and extending from the base of the frustoconical main body;
a second cylindrical channel having two open ends, coaxial with and passing through the main body and the attachment member, said second cylindrical channel being intersected by the first cylindrical channel; and
one or more gripping members extending from an outer surface of the attachment member, whereby a lure may be retained.

2. The fishing jig according to claim 1, wherein:
the first cylindrical channel is perpendicular to the second cylindrical channel.

3. The fishing jig according to claim 2, wherein there is a recess in a side adjacent to one of the open ends of the first cylindrical channel, suitably dimensioned and configured to allow a fish hook to be inserted into the first channel and then through a front portion of the second channel.

4. The fishing jig according to claim 2, wherein:
the gripping members are frustoconical flanges, having sides that slope in a direction opposite to the direction that a side of the main body slopes.

5. The fishing jig according to claim 2, wherein:
the gripping members are one or more screw threads.

6. The fishing jig according to claim 2, wherein:
the main body, the attachment member and the gripping members are made of brass.

7. The fishing jig according to claim 6, wherein:
the brass has a lead content of no more than five percent by weight.

8. A fishing jig, comprising:
a frustoconical main body;
a cylindrical channel having two open ends that passes through the main body;
an attachment member, having a general shape selected from the group comprising cylindrical, conical and frustoconical, said attachment member being coaxial with, and extending from the base of the frustoconical main body; and one or more gripping members extending from an outer surface of the attachment member, whereby a lure may be retained.

9. The fishing jig according to claim 8, wherein:
an axis of cylindrical channel is perpendicular to an axis of the frustoconical main body.

10. The fishing jig according to claim 9, wherein:
the gripping members are frustoconical flanges, having sides that slope in a direction opposite to the direction that a side of the main body slopes.

11. The fishing jig according to claim 9, wherein:
the gripping members are one or more screw threads.

12. The fishing jig according to claim 9, wherein:
the main body, the attachment member and the gripping members are made of brass.

13. The fishing jig according to claim 12, wherein:
the brass has a lead content of no more than five percent by weight.

14. A fishing jig, comprising:
a main body;
a channel having two open ends that passes through the main body;
an attachment member, extending from the main body; and
one or more gripping members extending from an outer surface of the attachment member, whereby a lure may be retained.

15. The fishing jig according to claim 14, wherein the main body is generally spherical.

16. The fishing jig according to claim 15, wherein:
the attachment member has a general shape selected from the group comprising cylindrical, conical and frustoconical; and
the channel is cylindrical and perpendicular to an axis of the attachment member.

17. The fishing jig according to claim 16, wherein:
the gripping members are frustoconical flanges, having sides that slope downward in a direction opposite to the main body.

18. The fishing jig according to claim 16, wherein:
the gripping members are one or more screw threads.

19. The fishing jig according to claim 16, wherein:
the main body, the attachment member and the gripping members are made of brass.

20. The fishing jig according to claim 19, wherein:
the brass has a lead content of no more than five percent by weight.
